(19) United States
(12) Patent Application Publication
(10) Pub. No.: US 2006/0241331 A1
(43) Pub. Date: Oct. 26, 2006

(54) Arrangement and method with thermal field for nuclear storage

(75) Inventor: George Danko, Reno, NV (US)

Correspondence Address: KLARQUIST SPARKMAN, LLP, 121 SW SALMON STREET, SUITE 1600, PORTLAND, OR, 97204, US

(73) Assignee: Board of Regents of the University and College Systems of Nevada

(21) Appl. No.: 11/357,302

(22) Filed: Feb. 17, 2006

Related U.S. Application Data
(60) Provisional application No. 60/654,202, filed on Feb. 17, 2005.

(51) Int. Cl. G21F 9/24

(52) U.S. Cl. 588/17

(57) ABSTRACT

The present disclosure provides methods and systems for storing nuclear material. According to a disclosed method, an amount of heat generated over a period of time by each of a plurality of nuclear storage containers is determined. A nuclear storage location in a material field having liquid passing through the material field is determined. A position is determined for a condensation gap in the material field. Locations are determined for first and second thermal zones in the nuclear storage location. The first and second thermal zones interact with the material field to produce the condensation gap. Based on the calculated amount of heat from each of the nuclear storage containers, the plurality of nuclear storage containers are placed in the material field to produce the first and second thermal zones.

### RELATED APPLICATION INFORMATION

The present application claims the benefit of U.S. Provisional Patent Application No. 60/654,202, filed Feb. 17, 2005, the disclosure of which is hereby incorporated by reference.

### FIELD

The present disclosure relates to the storage of nuclear material, such as high-level nuclear waste, for example, nuclear fuel from nuclear power reactors, in a material field, such as a geologic repository.

### TECHNICAL BACKGROUND

High-level nuclear waste should be isolated from the accessible environment, that is, the atmospheric and groundwater systems during the entire life of the radionuclides, which may stretch to hundreds of thousands of years. Geologic systems with geologic processes have been studied in an attempt to provide a credible solution for such long-term isolation. Geologic systems have been studied and understood and, based on their long-term behavior in the past, can be used to predict long-term behavior. This is why long-term isolation of the nuclear waste is typically designed in a geologic formation. Man-made systems have only a few thousand years record. The knowledge about manufactured materials is fractional and the predictions about their long-term behavior are speculative and extrapolative in nature.

The use of radioactive decay heat has been recognized and proposed, e.g., by Buscheck [1] and Rumspott [2], for improving waste isolation in an unsaturated formation such as at Yucca Mountain, Nev. Nuclear decay heat is a robust phenomenon, reliably available if it can be harnessed for improving waste isolation. Buscheck [1] argues that the benefit of heat may extend for 100,000 years. One problem with the previous solutions is that the positive effects of the decay heat upon the waste storage environment and isolation characteristics are typically difficult to predict and verify and, therefore, are still unreliable. Rumspott [2] considers elements of uncertainties, but concludes that above-boiling temperatures may be beneficial. The current, license-application design for YM is above-boiling, according to general, public information by the United States Department of Energy. A general reduction of moisture and potential water seepage on a large, site-scale was the goal in the previous solutions. The reduction of aqueous transport is an important qualifier for improving radionuclide isolation in an unsaturated environment. High-temperature, above-boiling operation, with no liquid water and aqueous transport for several thousands of years is an attractive solution, however, it is difficult to prove that the continuous water seepage and percolation from precipitation can be eliminated and/or stopped from breaking through the emplacement area for so long a time period over a large, continuous area. The large-scale “thermal shield” of the previous suggestion [4] may be prone to collapse due to local fractures and rock mass inhomogeneity.

### SUMMARY

The present disclosure provides an improved design as well as method for nuclear waste isolation from the environment.

In one aspect, certain embodiments of the invention involve the emplacement of nuclear waste, such as, for example, spent nuclear fuel, in an accessible area within a geologic formation situated above the watertable. The nuclear waste can be emplaced in one or more waste packages (WPs) in the emplacement area, which may comprise a tunnel or a drift. Certain embodiments of the invention can include a new waste isolation method by means of the temporary or permanent alteration of the geothermal, geohydrologic, and/or geologic conditions in the near-field rock environment of the area with the creation of localized, preferably de-saturated geologic thermal shields and/or shadows (TSS)), preferably through the use of nuclear decay heat and/or directional transport of vapor in the emplacement area.

Certain embodiments of the invention include design arrangements of the nuclear waste packages in the emplacement area for the development of one or more localized thermal shields and/or shadows. In certain embodiments such one or more shields or shadows can provide for the reduction or elimination of aqueous transport in the waste package near-field environment.

In certain environments, heat alone may not be enough to develop localized or de-saturated TSS that are also altered for decreased transport and therefore better performance in isolation in the near-field rock. In certain embodiments of the invention, un-altered rockmass areas can also be maintained adjacent the TSS for providing drainage channels. While the current, baseline solution at Yucca Mountain provides drainage channels only between entire emplacement drifts in the so-called pillar areas, certain embodiments of the invention can promote the development of drainage channels within the emplacement area at one or more locations provided by gaps between waste packages or by the area adjacent the TSS for one or more waste packages. The locations of the drainage channels between TSS areas or at least adjacent one or more such areas correspond to the location where condensation in the drift occurs during the high thermal activity of a few thousands years.

In certain embodiments, the dry and wet sections in an emplacement area can provide a dynamic balance for draining the continuous percolation water flux into the emplacement area originated by natural or other precipitation. In certain embodiments, dry sections under a localized heat load of a waste package may evaporate percolating or other water, which in the case of percolating water typically carries salts and minerals. In certain embodiments, evaporation of the percolating water in the near-field rock can deposit these minerals and clog up the fractures and the pores. This process can provide fracture healing. In certain embodiments, this process can contribute to the efficiency of the TSS as an altered near-field rockmass for reducing rock permeability and/or aqueous transport in the area. In certain embodiments, efficient evaporation can take place when the vapor generated by evaporation is transported away to vapor drainage, i.e., a condensation area. In certain embodiments, localized high and low temperature areas along an emplacement area can be engineered for the promotion of this process through TSS development.

One method of the present invention can utilize the differences and variations in temperature and moisture distributions in the near-field rockmass in order to provide waste containment, such as, for example, by using model-based engineering design. Robust physical processes causing differences can be modeled to understand and to enhance the positive effects of these differences upon waste isolation. In certain embodiments, the engineered barrier system (EBS) domain within the emplacement area with mobile air can be treated as a coupled, mountain-scale connection between hot and cold drift sections. In-drift moisture transport along a drift length as well as the condensate trapping process can be modeled and harnessed for moving water away from the WPs. In certain embodiments, this process may form a barrier for several thousands of years.

Certain embodiments of the invention include WP design arrangements. Horizontal and/or vertical, in-drift WP emplacement arrangements can be included as examples to promote condensate trapping in gaps. In certain embodiments, vertical in-drift WP emplacement can be included as an example to achieve longer gaps for the same emplacement density. In certain embodiments, mixed nuclear waste loading with cold and hot waste can be provided in one WP for TSS protection.

The methods and systems of the present disclosure can improve upon the shortcomings of prior system providing a man-made system that onsets geologic processes in the near-field environment and gives rise to an altered geothermal, geohydrologic, and/or geologic near-field environment that can improve the isolation of nuclear waste on the geologic timescale. While the disclosed methods and arrangements can provide a predictable improvement over current methods, embodiments of the present disclosure may still be embedded in a variable geologic environment with uncertainties. However, in certain embodiments these uncertainties are dealt with on a local and small scale, instead of a general and large scale, therefore, the uncertainties can be reduced in magnitude.

The foregoing and other objects, features, and advantages of the invention will become more apparent from the following detailed description, which proceeds with reference to the accompanying figures.

### DESCRIPTION OF THE FIGURES

Various embodiments are shown and described in connection with the following drawings:

FIG. 1: The concept of the thermal shields and shadows (TSS) formation

FIG. 2: Axial cross-section of drift

FIG. 3: Cross-section of drift through waste package along line 18

FIG. 4: Close up of drip cap in cross-section through waste package

FIG. 5: Three dimensional drawing of drip cap

FIG. 6: Installation of waste package, step 1

FIG. 7: Installation of waste package, step 2

FIG. 8: Installation of waste package, step 3

FIG. 9: Installation of waste package, step 4

FIG. 10: Roof block cave-in between waste packages

FIG. 11: Roof degradation between waste packages

FIG. 12: Isotherms around waste packages in the drift wall

FIG. 13: Thermally altered seepage/drainage

FIG. 14: Thermally altered seepage/drainage (cross section 16 through waste package)

FIG. 15: Thermally altered seepage/drainage (cross section 17 through drift)

FIG. 16: Axial cross-section of drift with clusters of WPs.

FIG. 17: A dual-barrier arrangement to keep away fallen rock from the WP

FIG. 18: Plan of conceptual emplacement panels at Yucca Mountain (Danko and Bahrami, 2004⁵).

FIG. 19: The rockmass domain around an emplacement drift in Panel 2.

FIG. 20: NUFT domain discretization grid

FIG. 21: CFD model configuration in the airway, (a) A repeated sequence of eight waste packages in an emplacement drift; (b) Schematic diagram of the pre-closure, powered ventilation model configuration; (c) Schematic diagram of the post-closure, natural air movement with model configuration axial dispersion

FIG. 22: Condensate formation based on partial vapor pressure trimming

FIG. 23: (a) Wall temperature; and (b) wall relative humidity distributions in time and space.

FIG. 24: Results of spatial distribution of waste package surface temperatures and relative humidity, and condensate values at years 1000, 1500, 3000, and 5000.

FIG. 25: Results of spatial distribution of drift wall temperatures, relative humidity, and condensate values at years 1000, 1500, 3000, and 5000.

FIG. 26: Waste package surface temperature and relative humidity vs. time, hottest and coldest packages are represented by dashed and solid lines respectively.

FIG. 27: Results of spatial distribution of waste package condensate for selected post-closure time divisions

FIG. 28: Results of spatial distribution of drift wall condensate for selected post-closure time divisions

FIG. 29: Comparison between the simplified robust moisture transport model results and the direct vapor inflow rates calculated by NUFT.

FIG. 30: (a) superheated steam (\dot{q}ₛₘ) and condensate (\dot{q}_{cm}) flux rates in the emplacement drift with time from the CFD solution in MF; (b) The total (barometric) pressure build-up in the drift to discharge the \dot{q}ₛₘ'1\dot{q}_{cm} excess steam into the unheated rockmass in horizontal direction.

### DETAILED DESCRIPTION

Description of items numbered in figures:
1: drift
2: drift wall
3: waste package
4: drip cap
5: pedestal
6: rock blocks
7: roof block cave-in
8: rubble
9: roof degradation
10: isotherm at temperature T₁
11: isotherm at temperature T₂<T₁
12: isotherm at temperature T₃<T₂
13: isotherm at temperature T₄<T₃
14: thermally altered percolation/seepage pattern
15: thermally altered drainage pattern
16: cross section plane through waste package
17: cross section plane through drift in the middle of the gap
18: cross section plane through waste package
19: in-drift condensates
20: water droplets
   Method Description

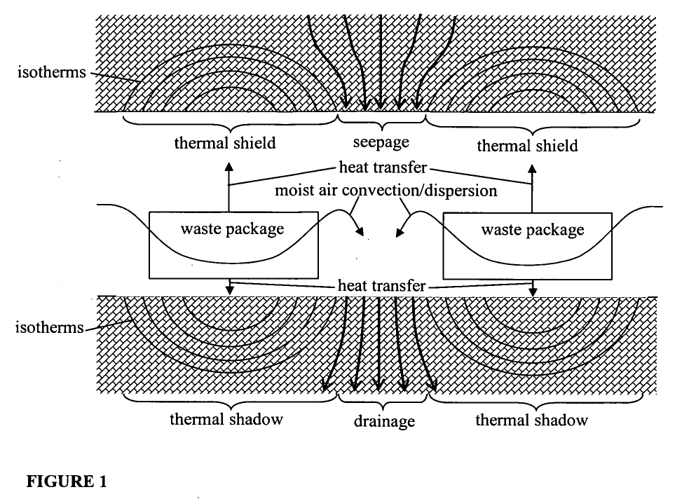

According to a disclosed embodiment, local temperature and de-saturation differences in a near-field rock area are established to provide a robust, physics-based, near-field barrier that effectively decreases near-field transport of radionuclides. FIG. 1 is an illustration of a thermal shield and shadow (TSS). Localized thermal shields are formed near the waste packages (WPs) in the unsaturated zone (UZ) against liquid water seepage above the emplacement drift; and localized thermal shadows below the WPs, prohibiting or reducing the development of aqueous transport of radionuclides in the UZ below the drift. The combined effects of the thermal shield and shadow (TSS) form a barrier during the thermally active time period of a few thousands year or even longer, depending on the thermal load used in the design. Beyond this timeframe, the permanent changes in the TSS during the active time period for TSS formation provide added protection. An example shows that the TSS may be effective for over 10,000 years without taking into consideration fracture healing.

Fracture healing and mineralization in the thermally altered TSS zone may extend the positive effects of the TSS into the entire, near-ambient operation timeline of the repository. At the same time, it is expected that the new WP arrangement and emplacement will require cost savings versus known solutions. In order to promote fracture healing, evaporation can be enhanced according to certain disclosed methods by providing condensate formation with drainage points using gaps between WPs. Condensate formation is used to stabilize the total, barometric pressure in the drift, and to prevent the total pressure increase due to superheated steam inflow from the rock into the drift. Condensate formation can reduce the steam/vapor content of the drift airspace, and can stabilize, i.e., by lowering the pressure, promoting evaporation in the hot drift sections.

In contrast, the current solution selected for example at Yucca Mountain (YM), aims at eliminating temperature variations and local differences. There is not enough of a gap between the WPs for drainage channels, and condensates may drain on cold WPs. The current assumption for YM is that the system increases its barometric pressure during the over-boiling operation time period for decreased vapor flow and drainage through the pillar area. This can minimize the mineralization potential in the near-field zone, minimizing fracture healing and missing the potential advantages of it.

New Waste Package Arrangement Description

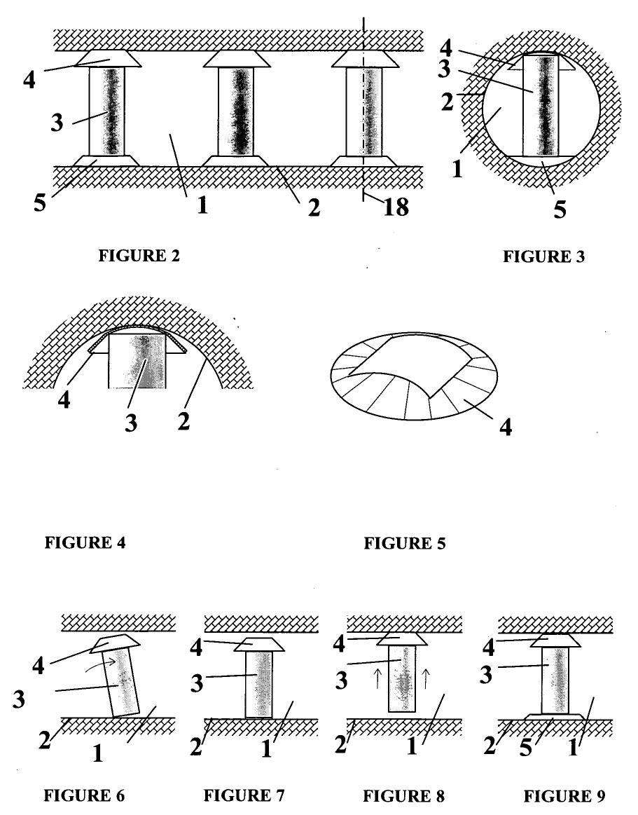

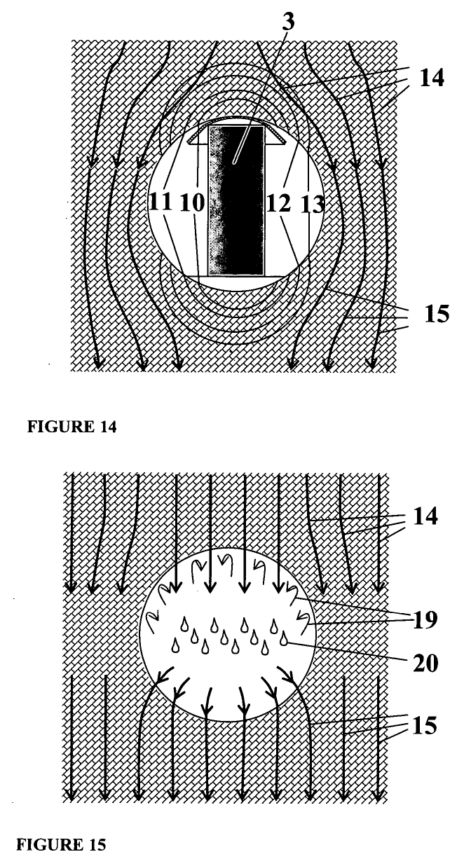

FIGS. 2-17 are examples of possible arrangements of the nuclear waste to be stored in a material field, such as the unsaturated environment known to be at Yucca Mountain, Nev. These arrangements are conducive to the development of TSS. An advantageous solution for TSS formation is shown in FIG. 2. The arrangement is vertical, giving space to gaps 1 between the WPs 3 that represent the heat source in the heat and moisture transport system. The WPs 3 stand on pedestals 5, which may be a composite combination of weight-spreading and bearing metal and a porous material for evenly spreading any radionuclide release from the WP 3. A drip cap 4 forms a connection between the WP 3 and a drift wall 2. The drip cap 4 may be a corrosion-resistant material, such as Alloy 22 or titanium. The drip cap 4 can also be used to divert any rock pieces falling from the roof. The drip cap 4 may be formed to provide a flexible connection between the WP 3 and a drift 1 for reducing the stress in the roof of the drift wall 2 and in the WP 3. A ceramic packing material between the WP 3 and the drip cap 4 may also be applied to separate metals for corrosion avoidance, not shown.

During the evolution of the TSS, accumulation of chloride and other corrosive materials from the evaporation of pore water in the rockmass may be of concern. Especially within the rockmass above the emplacement drift, such accumulation of chloride may problematic. Return of the percolation water in the long term may leach out chloride and wash it down to the WPs 3 containers and may cause corrosion failure. Accordingly, the drip caps 4 can be covered with, or made from, a corrosion-resistant material, such as a ceramic material. Corrosion may also be inhibited by reducing the maximum temperature below the boiling limit. The thermal shield and shadow effects will still be activated, but the amount of evaporation will be reduced, possibly by orders of magnitude. This reduction, in turn, can reduce the accumulation of chloride and other corrosive substances to insignificant levels. Naturally, less fracture healing may be created in the low temperature solution, but the system will still be in place, and its performance will be more predictable.

FIGS. 6 through 9 are 4 sequences of vertical WP emplacement. As shown, the WP 3 locks into a vertical position and, after the placement of pedestal 5, the vertical position becomes defined by the available clearance in drift 1.

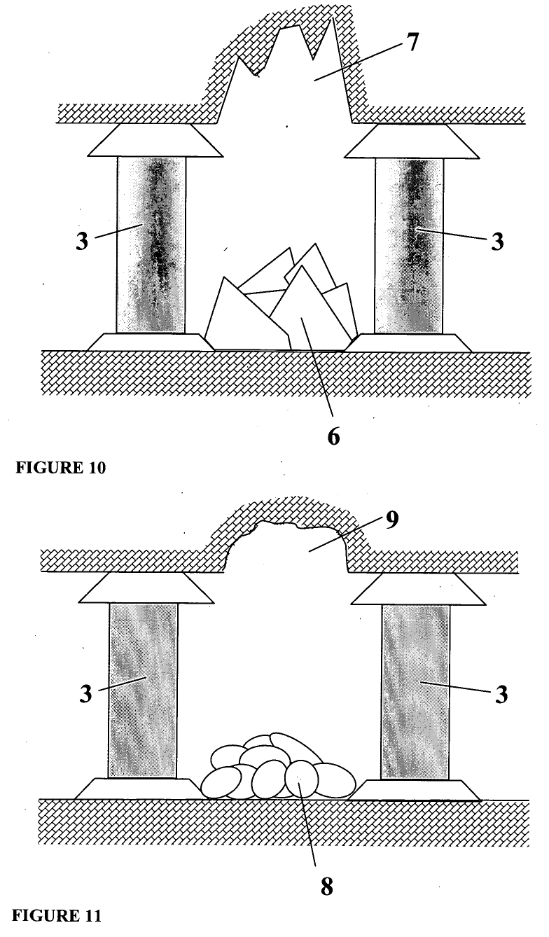

FIG. 10 shows an imaginary roof failure with falling rock blocks 6. FIG. 11 is a likely roof failure if rock conditions result in smaller fragmentation causing rubble 8 to fall. Neither roof block cave-in 7 nor gradual roof degradation 8 will cause seepage to the WP 3.

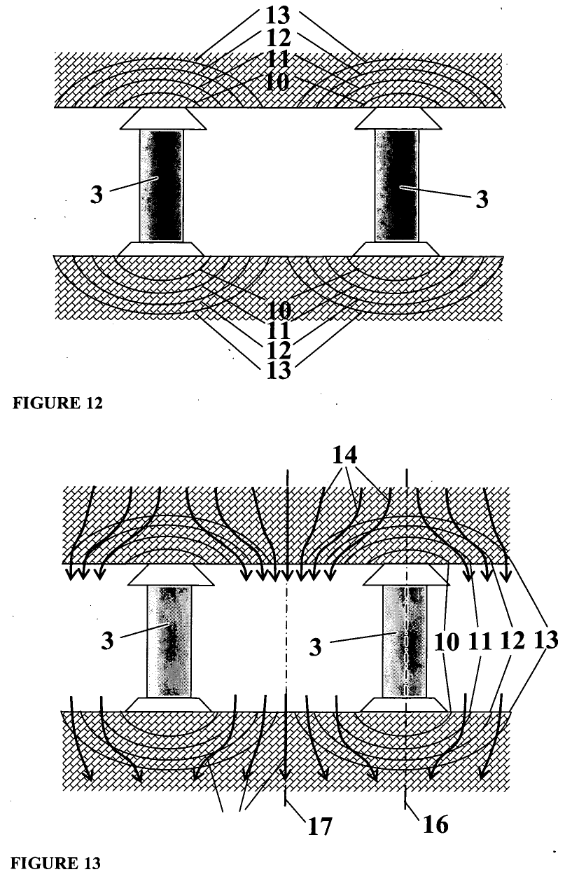

FIG. 12 shows imaginary isotherms. The closer isotherms 10 to the WP 3 will be naturally hotter with the saturation lower due to enhanced evaporation. FIG. 12 shows the thermally-altered percolation and seepage and drainage patterns 14 in the roof, as well as the drainage patterns 15 in the floor. Neither seepage nor drainage is expected in the TSSs close to the WPs 3 due to de-saturation. After the thermal alteration decreases to an insignificant level, the permanent alteration due to fracture healing will remain, benefiting waste isolation. The cross-sectional patterns in sections 16 and 17 show that the TSS works around the WP 3, while in the empty gap 17, drainage is actually enhanced and promoted by condensation 19 and drippage 20.

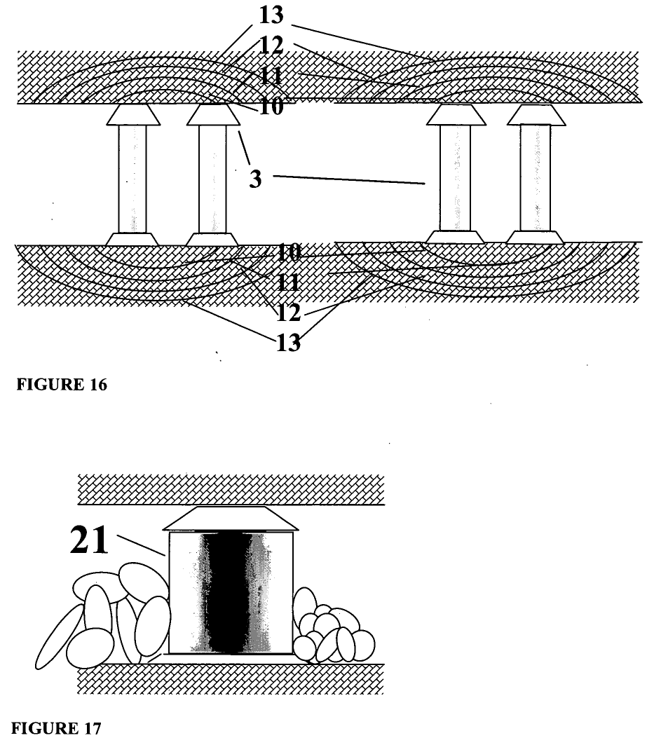

FIG. 16 shows the TSS formation with clusters of WPs. Although the example shows only two WPs in one cluster, any other number may be used, depending on the thermal design. Clustering of WPs is advantageous if cold WP needs the benefit of a hot WP for common TSS development. Similar advantage can be achieved putting different nuclear waste types with different heat dissipation in one package, known to be as blending or co-disposal. This way, sufficient head source can be provided for efficient TSS formation.

FIG. 17 is a dual-barrier vertical emplacement, having an outer shield 21 for keeping fallen rock away from the WP 3 wall. This separation can be advantageous for reducing direct contact with rock that may induce corrosion on the WP surface if wetness or fallen rock blocks 6 or rubble 7 are present.

WP arrangements other than the ones shown as examples may also be used to form TSS. An example for horizontal WP arrangement is provided in which seven different WPs with different heat load values are arranged for increasing the temperature differences between them along the drift length. The example shows the positive effect of the concept in localizing the wet drift sections to a much shorter length than it would be with a more even distribution of the heat load along the drift length.

### REFERENCES

1. D. Ramspott, “The Constructive Use of Heat in an Unsaturated Tuff Repository,” Proc. 2^{nd} Annual Int. Conf. High Level Radioactive Waste Management, Las Vegas, Nevada, April 28-May 3, 1991, p. 1602-1607.

2. Buscheck and J. J. Nitao, “The impact of Thermal Loading on Repository Performance at Yucca Mountain,” Proc., 3^{rd} Annual High Level Radioactive Waste Management Conference, Las Vegas, Nev., 1992, p. 1003-1017.

3. Yucca Mountain Site Characterization and License Application Support Documentation.

### EXAMPLE

### Introduction

The waste package design as well as its temperature and humidity, i.e., the psychrometric environment are equally of great importance in meeting the primary goal of long-term safe storage of high-level nuclear waste at Yucca Mountain. The waste packages and drip shields may have been designed with excessive conservatism and perhaps unnecessarily expensive in the current, license application design by USDOE. An alternate design is proposed by Kar et al [Kar et al, 2005¹] that would ensure a level of safety equivalent to that of the current design at a 25% cost reduction. Cost reduction would result due to an alternative container material as well as WP enlargement, reducing the number of WPs for the same storage capacity. An increase in the WP thermal load according to the proposed design will increase temperatures, and through the thermal-hydrologic coupled processes, will positively affect the psychrometric storage environment in the entire emplacement drift. This Example addresses this issue, and provides a complete, spatial and temporal thermal, hydrologic, and humidity storage environment for the WP in a representative emplacement drift by numerical simulation. MULTIFLUX² (MF), a multi-scale, coupled, thermal-hydrologic, air flow and condensate model and software [Danko, 2000⁵, incorporated by reference herein] is used for the current study to model the flow of heat, moisture, and air in an emplacement drift.

MF applies a universal coupler that connects the heat and moisture transport models in two different domains: (1) the rockmass, and (2) the airway with the heat-generating nuclear waste packages. In the three-dimensional rockmass, MF employs NUFT (Nitao, 2000³, incorporated by reference herein) the results of which are re-processed using the NTCF modeling technique (Danko, 2004⁴, incorporated by reference herein). In the emplacement drift, a lumped-parameter, Computational Fluid Dynamics' (CFD) model is used [Danko and Bahrami, 2003⁵, 2004⁶, each of which is incorporated by reference herein] in MF.

Description of the Multi-Scale Thermo-Hydrologic Model

The Integrated Pre- and Post-Closure Task

Temperature and relative humidity variations are analyzed from the beginning of waste emplacement for a 5,000-year period that includes two distinct thermal cycles, one during the pre-closure, and one during the post-closure time periods. During pre-closure, the drift is mechanically ventilated with a forced, constant airflow rate of 15 m³/s for 50 years. After the pre-closure period, the access shafts and connecting tunnels are backfilled and sealed, and the emplacement drifts are exposed only to natural air movement. It is assumed that the emplacement drifts are not backfilled, and that the gradual collapse of the drifts over time will not prevent the natural air movement around the WPs.

The Conceptual Repository Arrangement and Model

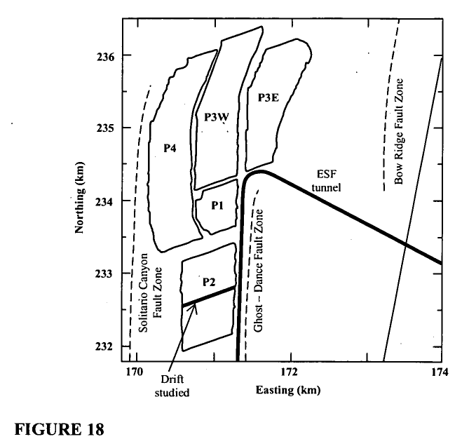

The arrangement follows the conceptual design developed by the US Department of Energy using five emplacement panels at YM, shown in FIG. 18. One emplacement drift at the center location of Panel 2, previously referred to as Panel 5 [Danko and Bahrami, 2004⁵], is selected for the present analysis. Panel 2 is surrounded by unheated edges and, therefore, will develop a temperature field colder around the edges than in the center. A transport of moist air along the length of the drift with such a temperature distribution in any direction may give rise to moisture condensation along the relatively cold edge sections. This edge-cooling effect phenomenon will affect all the panels shown in FIG. 18, but Panel 2 is selected for its modeling simplicity.

Post-closure, natural airflow in the drift will develop due to the temperature differences between the waste package surfaces and the drift wall. The large eddies caused by the vertical air movement will effectively establish an axial transport of heat and moisture along the drift by dispersion [Webb and Itamira 2004⁷]. Although other, axial transport mechanisms may also be present during post-closure in addition to dispersion, such as axial, buoyancy-pressure-driven air infiltration [Danko and Bahrami, 2004⁶], these effects are neglected in the present analysis. Under certain conditions in the emplacement drift, condensation may occur, generating liquid-phase water on the drift or WP surfaces, or in the air. The thermohydrologic model configured in the lumped-parameter CFD of MF includes model-elements that describe the natural, small-scale air movement and related psychrometric processes in the emplacement drift.

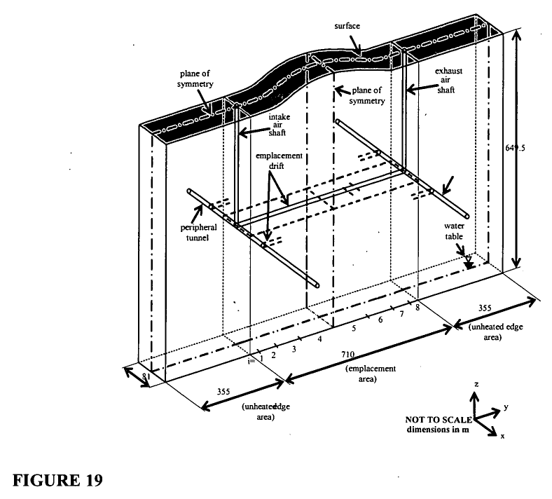

The geometry of the rockmass surrounding the center drift in Panel 2 is shown in FIG. 19. Two peripheral drifts, located perpendicular to emplacement drifts are depicted in FIG. 19 together with two vertical shafts, an intake and an exhaust that are typically used to connect the peripheral drifts to the atmosphere in a panel for pre-closure ventilation. The peripheral drifts and the shafts, however, are assumed to be backfilled and completely sealed during the assumed repository closure at year 50.

The Models of the Rock Domain

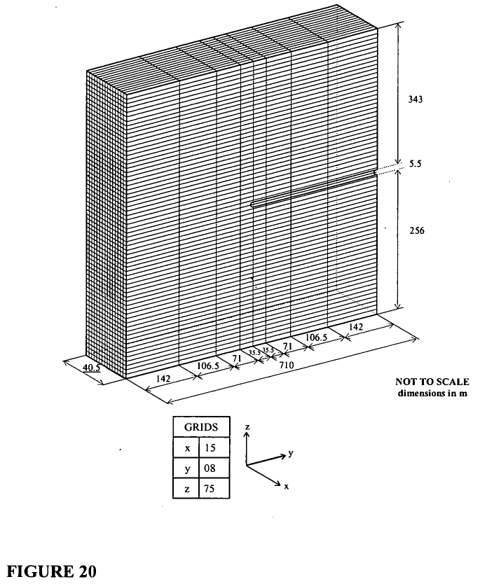

The NTCF heat and moisture flow models of the rock domain are generated in MF using NUFT³. The geometrical domain, shown in FIG. 19, is simplified for the NUFT runs for reducing the computational capacity and runtime. First, it is halved by the vertical symmetry plane along the drift centerline. Second, the rockmass is further halved along the length of the drift. A symmetry is assumed between i=4 and i=5, along an adiabatic surface that divides the entire rock domain into two mirrored halves, an entrance and an exit drift section area. These simplifications reduce the computational rock domain to a quarter of that in FIG. 19, however, two consecutive NUFT models are needed to deal with asymmetries in the temperature field, caused by the pre-closure air ventilation that is from left to right in FIG. 19. The reduced rock cell with its internal grids is shown in FIG. 20. Each NUFT domain includes four rock cells along the drift and another four cells in the edge regime, all fully connected regarding heat and moisture flows. The number of nodes in each three-dimensional (3D) NUFT domain is 15×75×8, providing adequate discretization and acceptable grid independence. The grid in the x and z direction is identical to the two-dimensional discretization that was applied and verified in the AMR Rev01D work conducted by USDOE⁸.

The entire drift is surrounded by four sections in the first, and four sections in the second NUFT rock domain, giving eight 3D mountain-scale cells (i=1 . . . 8). The two planes of symmetry that are included in the rock model but not in the model of the airway result in only a small model error while reducing the computer memory requirements to a quarter.

The numerical model assumes a porous, wet, but unsaturated rock formation in which both heat and moisture transport are present and affect the thermal and psychrometric waste container environment. The rock properties with dual-porosity elements in NUFT 3.0s were used identical to those applied by USDOE⁸ for a representative stratigraphic block at YM.

Initial and Boundary Conditions

The atmospheric climate boundary conditions on the surface were varied according to the modern-time, monsoon, and glacial-transition cycles with time. The known, constant virgin rock temperature and 100% water saturation were applied at the bottom of the rock domain, representing the water table. On the other outside vertical planes, the rock domain is assumed to be adiabatic. Boundary conditions on the drift surface are defined and discussed later in the paper when describing the NTCF rock model.

The temperature and moisture saturation initial conditions in the rockmass at the time of waste emplacement were initialized by simulating 10 complete climate cycles of 74,000 years each as the likely pre-history for the current conditions at YM (USDOE⁹).

The NTCF Model of the Rock Domain

A modeling method called NTCF is used in all versions of MF, to re-process the time-dependent heat and moisture responses from the thermohydrologic NUFT model into matrix equations [Danko, 2004⁴]. A linear NTCF processor is applied in the present Example, using first-order matrix polynomial equations for modeling heat and moisture fluxes on the drift surface boundaries with constant-coefficient matrices. During the NUFT runs, the input boundary conditions on the drift surface are temperature and partial vapor pressure functions, varying with time and location. In addition, the total barometric pressure is also prescribed as boundary condition for the NUFT runs. The output variables from NUFT are spatial and temporal heat and moisture flux variations on the drift wall. The NTCF procedure determines dynamic admittance matrices from the NUFT input and output functions. The NTCF model matrices represent connections between inputs and outputs. Within the useful application regime of the NTCF model, the dependence of the matrices is negligible upon the input boundary conditions used in the NUFT calculations. The NUFT input boundary conditions for which the NTCF model is determined are called the central values of NTCF. The mountain-scale NTCF model for the i^{th} rock cell (i=1 . . . 8, see FIG. 2) along the drift length expresses the time-dependent, wall heat (qh) and moisture (qm) fluxes as follows:
qhᵢ=hhᵢ·[Tᵢ−Tinitᵢ]+hmᵢ·[Pᵢ−Pcᵢ] (1)
qmᵢ=mhᵢ·[Tᵢ−Tinitᵢ]+mmᵢ·[Pᵢ−Pcᵢ] (2)

where qhᵢ and qmᵢ are vectors composed of heat and moisture flux elements at time divisions t₁, . . . ,t_{N}; Tᵢ and Pᵢ are wall temperature and partial vapor pressure vectors; Tinitᵢ is the initial, constant wall temperature; while Pcᵢ is the partial vapor pressure variation vector for the predicted, central condition around which the NTCF model is determined. Dependence of the NTCF model on the central values, Tcᵢ for temperature and Pcᵢ for partial vapor pressure, is eliminated by iteration as discussed later in the paper. In Eq. (1), the hhᵢ is a dynamic admittance matrix of heat flux, generated by the wall temperature driving force, and hmᵢ is another, cross-effect component matrix of heat flux, generated by the wall partial vapor pressure driving force. Similarly, mhᵢ and mmᵢ are dynamic admittance matrices for the moisture flux expression in Eq. (2). The hhᵢ, hmᵢ, mhᵢ, and mmᵢ are all N×N matrices, determined using the NTCF modeling method [Danko, 2004⁴].

Within each 3D mountain-scale rock cell (i=1 . . . 8), further divisions are made to capture the drift-scale temperature and humidity variations along the drift. While the numerical discretization points on the drift wall in each cross-section are still bundled by averaging into a surface node, 420 independent nodes are generated from the 8 divisions along the drift length for giving details in the refined NTCF model. Each mountain-scale rock cell for i=1 . . . 8 is re-scaled into j sub-divisions according to Table 1. The re-scaling of the hhᵢ, hmᵢ, mhᵢ, and mmᵢ mountain-scale 3D cell matrices into drift-scale hhᵢⱼ, hmᵢⱼ, mhᵢⱼ, and mmᵢⱼ matrices are accomplished by proportioning them by the ratio between the i^{th} cell and the ij^{th} drift segment surfaces, Aᵢ and Aᵢⱼ:

$$\begin{matrix}{hh}_{ij} = {hh}_{i} \cdot \frac{{A}_{ij}}{{A}_{i}} & ( 3 ) \\ {hm}_{ij} = {hm}_{i} \cdot \frac{{A}_{ij}}{{A}_{i}} & ( 4 ) \\ {mh}_{ij} = {mh}_{i} \cdot \frac{{A}_{ij}}{{A}_{i}} & ( 5 ) \\ {mm}_{ij} = {mm}_{i} \cdot \frac{{A}_{ij}}{{A}_{i}} & ( 6 )\end{matrix}$$

The re-scaling procedure generates 420 individual drift-scale hhᵢⱼ, hmᵢⱼ, mhᵢⱼ, and mmᵢⱼ “daughter” matrices without any additional NUFT runs, all inheriting the mountain-scale heat and moisture transport connections from the original, mountain-scale, “parent” matrices hhᵢ, hmᵢ, mhᵢ, and mmᵢ. The average size of the spatial rock domain in the axial drift direction is 1.7 m that is sufficient to generate temperature variations even along individual waste packages. The multi-scale NTCF rock model defines heat and moisture flux vectors as a function of the 420 time-dependent input vectors of surface temperature and partial vapor pressure boundary conditions. It is important to emphasize that both the heat and moisture fluxes as well as the temperature and partial vapor pressure vectors are all considered unknown at this point and subject to coupling calculations with the in-drift CFD models for the drift. The central-value dependence of the first-order NTCF model is relatively minor and dealt with by an outside iteration as discussed later. The 420 nodes represent the interface boundary at selected points between a rock cell and the airway that include the waste packages. The NTCF rock model includes both drift-scale and mountain-scale heat and moisture flow components without using any sub-models and/or any superpositions.

The axial, y-directional heat conduction in the rockmass along the length of the drift is included in the NTCF model from the coarse discretization. The drift-scale “daughter” matrices inherit the axial heat conduction and moisture diffusion connections from their mountain-scale “parent” matrices during re-scaling. These axial connections, however, do not account for the axial heat and moisture fluxes in the rock in the close vicinity of the drift wall, caused by axial gradients within each mountain-scale cell. In the current study, a simplified approach is used by adding axial connections to the model. For fine, drift-scale, axial heat conduction modeling, the thermal conduction connection of a 10 m-thick tubular rock layer is added to the interface nodes of the in-drift model. This connection between the neighboring wall nodes along the drift length is calculated and applied in the CFD model to “smoothen” the temperature variation that is caused by the individual WP heat load variation. However, no additional drift-scale, axial moisture/vapor diffusion connection is applied in the present analysis.

The linear NTCF model requires a few update iterations. These NTCF matrices are iteratively re-calculated from new NUFT run results that are obtained with better and better central values as obtained from the coupled model calculations. The present solution is based on the third iteration of the NTCF module with respect to the thermal model. In the third iteration, the NTCF thermal model is determined based on using the output of the second iteration as central values for the NUFT runs. The moisture transport NTCF model is iterated only two times, starting with the robust model concept [Danko and Bahrami, 2004⁶]. The first iteration of the approximate model for the moisture flow across the drift wall assumes that 100% of water percolation flow from precipitation on the ground surface reaches the drift footprint. The NTCF sub-model for moisture is replaced by a time-dependent, but temperature-independent and simplified model in the first iteration. The time-dependent moisture flux used in the first iteration is given in Table 2. In the second iteration, the moisture fluxes are corrected according to the first-order NTCF sub-model, determined based on NUFT results for the balanced temperature and humidity boundary conditions. These iterations in the NTCF models provide adequate model accuracy, based on previous application experiences^{5,6,8}. The comparison between the robust, percolation-based water flux and the NUFT-based moisture flux distributions is very useful in understanding the nature of water drainage through the emplacement drift. A question will be discussed based on the simulation results, namely: does the drift “shadow,” or, quite contrary, “attract” water flow? In the third iteration, the NTCF model is determined based on using the output of the second iteration as central values for the NUFT runs.

The Model of the Airway With the Waste Containers

The CFD Models for Heat and Moisture Transport in MF

The energy balance equation in the CFD model of MF is used in a simplified form, as follows, for an x-directional flow with vᵢ velocity in a flow channel of cross section dy times dz:

$$ρ c \frac{\partial T}{\partial t} + ρ {cv}_{i} \frac{\partial T}{\partial x} = ρ ca \frac{{\partial }^{2} T}{\partial {x}^{2}} + ρ ca \frac{{\partial }^{2} T}{\partial {y}^{2}} + ρ ca \frac{{\partial }^{2} T}{\partial {z}^{2}} + {\dot{q}}_{h} \qquad ( 7 )$$

In Eq. (7), ρ and c are density and specific heat of moist air, a is the molecular or eddy thermal diffusivity for laminar or turbulent flow, respectively, and \dot{q}ₕ, is the latent heat source or sink for condensation or evaporation, respectively. Equation (7) is discretized and solved numerically and simultaneously along all parallel flow channels for the temperature field T in MF. The parallel flow channels represent the natural coordinate system of the flow field that must be known for the calculations. A few, typical flow velocity profiles are built-in functions in MF. Various boundary conditions, such as given wall temperature, heat flux, or convective coupling with a given heat transport coefficient across a boundary layer or sub-layer, may be applied for the solution of the energy equation.

An example of the solution to Eq. (7) was published and compared with FLUENT, as well as with experimental, published results for turbulent flow [Danko and Bahrami, 2002¹⁰]. A 150 m long drift section of was discretized into 50 segments along the airflow with heat generating WP along the length according to the conceptual design for YM. In the annulus between the waste packages and the drift wall, 60 unequally spaced segments were used along the radius. The flow was assumed to be fully developed hydraulically when entering the drift section. The eddy diffusivity and the velocity profiles were obtained from the dimensionless equations published by Kays and Leung¹¹. and were built into MF. The results showed excellent agreement between MF, FLUENT, and the experimental results.

The simplified moisture transport convection-diffusion equation in the CFD model of MF is similar to Eq. (7) as follows:

$$ρ \frac{\partial {ρ}_{v}}{\partial t} + ρ {v}_{i} \frac{\partial {ρ}_{v}}{\partial x} = ρ D \frac{{\partial }^{2} {ρ}_{v}}{\partial {x}^{2}} + ρ D \frac{{\partial }^{2} {ρ}_{v}}{\partial {y}^{2}} + ρ D \frac{{\partial }^{2} {ρ}_{v}}{\partial {z}^{2}} + {\dot{q}}_{c m} + {\dot{q}}_{sm} \qquad ( 8 )$$

In Eq. (8), ρᵥ is the partial density of water vapor, D is the molecular or eddy diffusivity for vapor for laminar or turbulent flow, respectively, \dot{q}_{cm} is the moisture source or sink due to condensation or evaporation, respectively, and \dot{q}ₛₘ is the vapor flux in superheated steam form.

It is possible to reduce the number of discretization elements in the computational domain by lumping nodes. MF allows for defining connections between lumped volumes, applying direct heat and moisture transport relations between them. A large selection of transport coefficient-based models is available for the user for laminar and turbulent flows as well as for natural convection. When only a few flow channels are used in the model configuration, such as in the present paper, a lumped-parameter CFD model is realized.

In the present example, the entire emplacement drift is 710 m in length, housing a total of 140 waste packages. The current lumped-parameter CFD model for heat transport in the airway applies 2544 nodes for the entire drift. Each WP is represented by two nodes, with one additional node for the gap between neighboring containers. CFD nodes are in the airway along three longitudinal lines: (1) close to the WP, (2) close to the wall above the WP, and (3) close to the side wall, with 424 nodes on each line. The drift inside wall is assumed to be separated from the rock wall with a 1.0*10⁻⁵ m-thick still air layer, and are both represented by 424 nodes each. Of these numbers, some nodes represent a short unheated section at both ends as well as the incoming air connections for the pre-closure ventilation task. The same number of nodes is used in the CFD model for moisture.

In the CFD domain, a sequence of eight different (two halves and six full) waste packages, shown in FIG. 4a, is first mirrored to form a 16-package sequence, and second, repeated 10 times in the emplacement drift. Drip shields are not included in the present analysis. The heat and moisture transport CFD models of the emplacement drift are integral, continuous 3D models.

In the pre-closure models, heat and moisture transport by turbulent convection are applied on the drift wall and the WP surface. The heat and moisture transport coefficients in the annulus between the waste containers and the drift wall are calculated in MF using transport coefficients in the lumped-parameter CFD during pre-closure. Thermal radiation between the waste packages and the drift wall, between waste packages, as well as between drift wall segments are incorporated in the CFD models. The axial convection connections along the three airlines are modeled according to the convective terms in Eqs. (7) and (8).

In the post-closure CFD models, natural, secondary flow is considered due to the local temperature differences in the drift. The average of the axial air flow is assumed to be zero in the present case, unlike in previous studies^{5,6} with various in-drift air infiltration assumptions. In each drift segment of a half-WP length, the re-circulating mass flow rate in the vertical plane is taken as 0.04 kg/s, a constant value for the study time period between 60 and 5000 years, based on the FLUENT simulation results of natural convection studied and published by Webb and Itamura⁷. The axial connection between the air nodes are bi-directional, representing dispersion. A constant dispersion coefficient of 0.1 m²/s is used, after Webb and Itamura.⁷ The dominantly natural heat transport coefficient on the drift and waste package walls during post-closure are all set to a constant value of 1.85 W/(m²K), a value consistent with the results of more detailed numerical modeling published by Webb et al.¹².

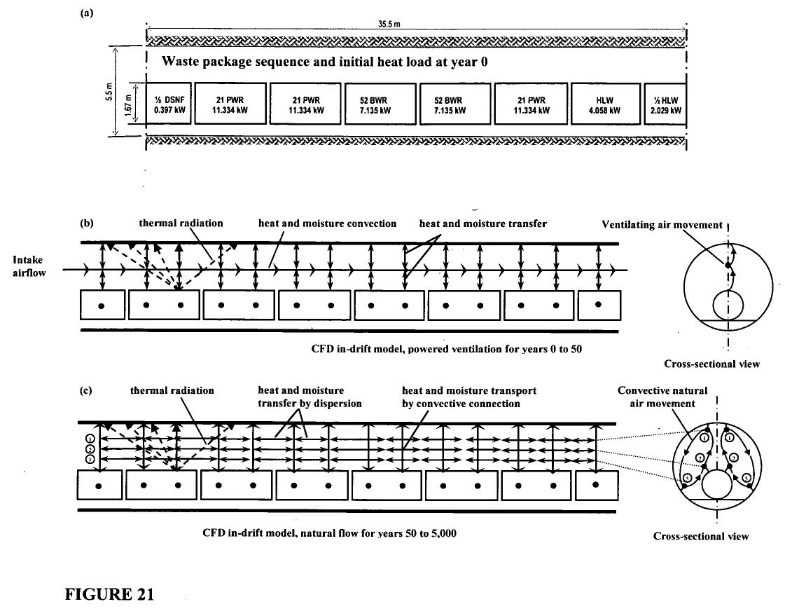

The two different CFD model configurations, used in the calculations for the pre-, and post-closure time period are shown in FIG. 21b and 21c. The pre-closure configuration in FIG. 21b is a convective model, assuming that the air moves along the drift caused by forced ventilation, removing heat and moisture from the drift wall surfaces. The flow path in this model assumes shear turbulent flow along the drift. The post-closure configuration in FIG. 21c, is a natural convection model with directional airflow patterns separating the drift wall nodes from the waste package surface nodes in each cross-section. Therefore, the convective heat and moisture transport connections between the drift wall and the waste packages are oriented by the moving air, shown in the cross-sectional view of FIG. 21.c.

Condensate Formation Modeling

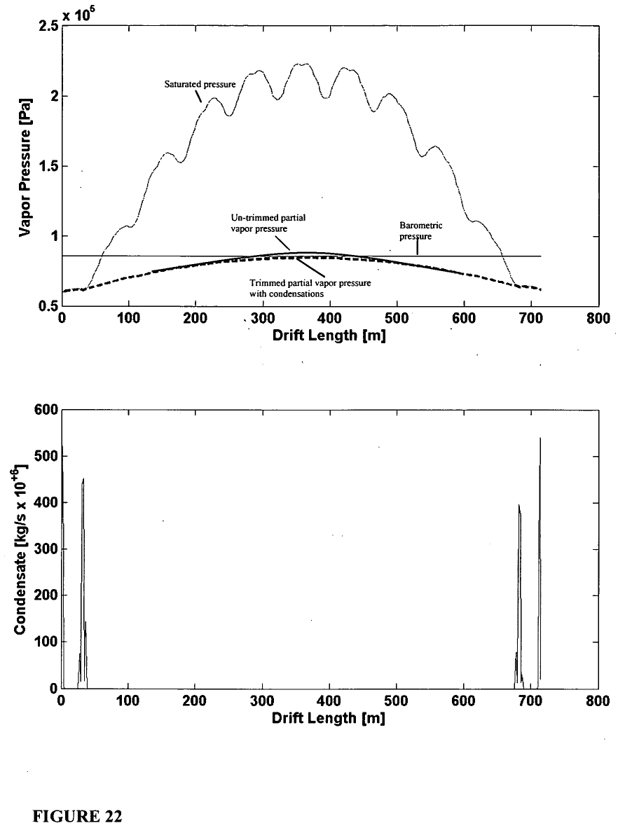

Condensate formation is modeled based on partial vapor pressure trimming in the moisture transport CFD sub-model solution in MF [Danko and Bahrami, 2004⁶]. An example is given in FIG. 22, showing the saturated vapor pressure, the un-trimmed and trimmed partial vapor pressures as well as the barometric (total) pressure on the drift wall along length. The results in FIG. 22 were obtained for demonstration purposes by stopping the MF run at the end of the balancing iterations at year 1500, and accessing the internal variables. The un-trimmed partial vapor pressure curve section above the barometric pressure limit is hypothetical, since the moisture CFD model in MF enforces the partial vapor pressure, Pᵥ, to stay between physical limits. The pressure-trimming enforcement is accomplished by iteratively, numerically adjusting the \dot{q}ₛₘ(i) and \dot{q}_{cm}(i) terms in Eq. (8) for each grid in the CFD model domain until the following conditions are met:

a. Condition for Superheated Steam Removal
increase (−)\dot{q}ₛₘ(i): if Pᵥ(i)>P_{b}(i) and Pₛ(i)>P_{b}(i) (9)
b. Condition for Conderisate Removal
increase (−)\dot{q}_{cm}(i): if Pᵥ(i)>Pₛ(i) and Pₛ(i)≦P_{b}(i) (10)
where

Pᵥ is the partial vapor pressure,

Pₛ is the saturated vapor pressure, and

P_{b} is the total, barometric pressure.

Initially, all flux terms \dot{q}ₛₘ, and \dot{q}_{cm} are set to zero for all nodes. Condensate or superheated steam fluxes are identified implicitly and numerically from the correct mass balance equations represented by the CFD model. The identification is simultaneously performed during the balancing iterations between the CFD and NTCF models. Condensate may be detected at surface nodes or at nodes assigned to air; in the later case, the condensate is assumed to be mist. The fate of the condensate by drainage, or condensate imbibing into the rock wall is currently not modeled, but this effect is likely to be important and subject of future studies with MF. The current model assumes that the condensates gracefully drain through the rock. The \dot{q}ₕ and \dot{q}_{cm} terms in Eqs. (7) and (8) are linked through the latent heat of water evaporation in MF.

Total System Model

The NTCF and CFD models are coupled on the rock-air interface by MF until the heat and moisture flows are balanced at the common surface temperature and partial vapor pressure at each surface node and time instant. The solution of the coupled thermohydrologic-ventilation model includes two subsequent iteration loops:

1. Heat balance iteration between the NTCF and airway CFD models for each time division.

2. Moisture balance iteration between the NTCF and airway CFD models for each time division.

As explained in the NTCF model description, three total model iterations were performed during the solution, incorporating NTCF re-functionalizations. In previous studies^{5,6}, a small air infiltration was assumed across the emplacement drift driven by a natural buoyancy pressure difference in the air between the hot emplacement area and the unheated environment. During these previous studies, it became apparent that the fractured and porous rock at YM allows for some airflows and that it may be quite reasonable to assume an open system regarding the total barometric pressure in the emplacement drift. Based on this previous observation, a model concept is applied in the present Example, namely, that the total pressure in the emplacement drift equals that of the hydrostatic barometric pressure in an open system kept at the same temperature and humidity conditions.

### Input Data

The input data used in the calculation essentially agree with those used in the AMR Rev01 study⁸. The main input parameters are given in Table 3. Other input data used in MF and NUFT are documented in a report submitted to BSC [Danko et a., 2003¹⁴].

### Results and Discussions

Temperature and Relative Humidity Distributions

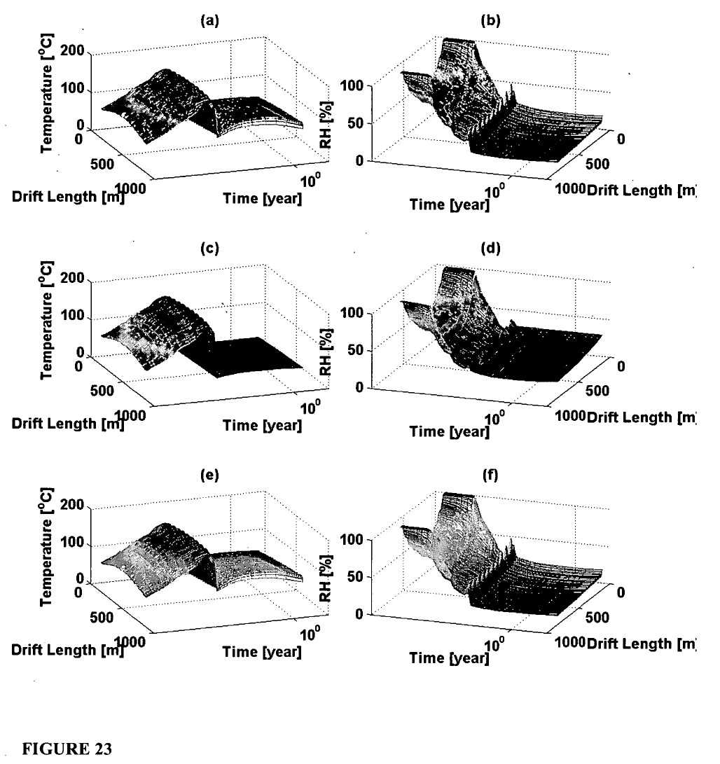

Pre- and post-closure, spatial and temporal temperature and relative humidity variations from the MF calculations are given for the representative drift in FIG. 23. Sub-figures a, c, and e depict temperatures of the drift wall, air, and the waste packages as a function of time and drift length. Sub-figures b, d, and f show the relative humidities on the surface of the drift wall, in the air, and on the waste packages as a function of time and drift length.

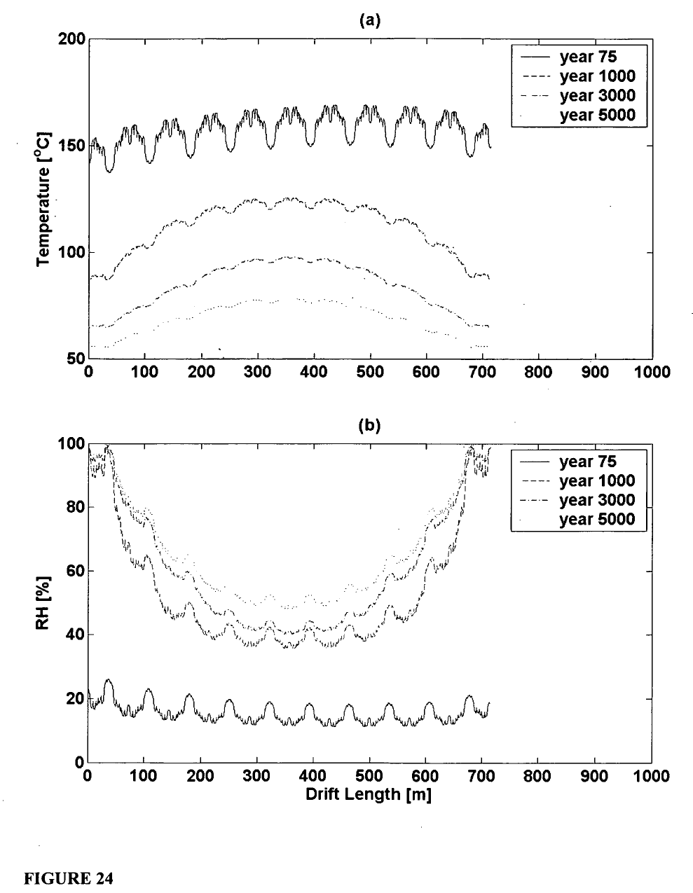

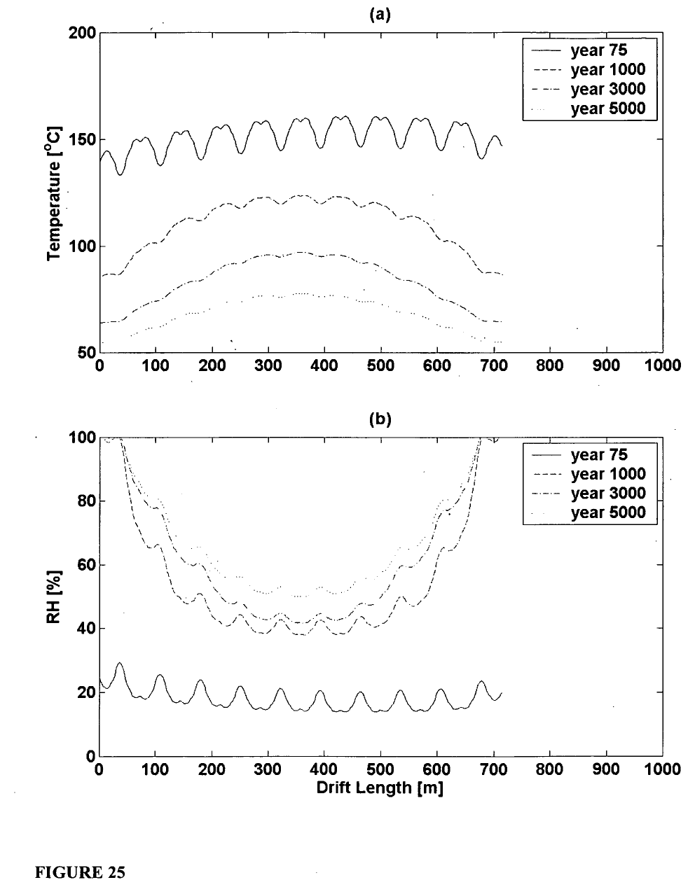

FIGS. 24 and 25 show two-dimensional spatial distributions for temperature and relative humidity along the drift for selected post-closure time periods for the drift wall and the drift centerline, respectively.

The evolution of two thermal peaks are shown in the temperature variations for the drift wall, shown in FIG. 23a, one around year 5 during pre-closure, and one between years 75 and 100 during post-closure, depending on the drift location. The second peak is reached relatively rapidly, due to the young age of the waste and the short pre-closure ventilation time period, when compared to a previous study¹⁴ in which the time for peak temperature evolution during post-closure was about 1000 years, following a 300-year pre-closure ventilation. The second peak is much higher in amplitude, underlying the criticality of the post-closure analysis, for both the maximum temperature evolution as well as the threshold limitation for localized corrosion. Waste package temperatures exceed 140° C. a temperature perfectly compatible with a low-alloy steel such as CORTEN, but a critical value for likely localized corrosion for Alloy 22 waste package material [Farmer, 2003¹⁵]. This condition is predicted for an extended period of time and for a large section of emplacement drift with over 100 waste packages. If drip shields were included in the calculation, the predicted temperatures of the waste package surface would rise even higher. The longitudinal, saw-tooth-like fluctuations in both temperatures and relative humidities, shown in FIG. 24 as a close-up view, are caused by the variation of the heat dissipation of the individual waste packages.

The maximum differences between the drift wall and air, as well as between waste packages and air, are only about 10° C. at the time of the peak temperatures and lower afterward. Under this condition, the buoyancy driving force for local, natural air convection in each drift cross section is moderate, with a Rayleigh number in the order of 10⁹ and with a natural heat transport coefficient around 1.85 W/(m²K) between the waste package and the air, as well as between the air and the drift wall. The convective heat transport in this case is lower than the heat transport due to radiation that is a parallel, bypass mechanism to convection, modeled in the lumped-parameter CFD model. Therefore, the sensitivity to the convective heat transport coefficient in this regime is moderate, and the lumped-parameter CFD model based on heat transport coefficients was not seen to be in need of replacement with more elaborate heat and moisture convection elements.

The drift wall temperature variation along the drift axis is very significant, over 40° C. between years 1000 and 3000, shown in FIG. 24. From a few hundred to a few thousand years, the edge-cooling effect generates significant axial temperature variation within the drift since the waste decay heat is still strong enough to heat the middle section of the drift, but the time is already long enough to cool down the edge area. A small-scale, axial temperature variation is dominant for only a few hundred years after closure as a “superimposed” wave upon the mountain-scale trend. As shown in FIG. 24, the axial, drift-scale temperature varies periodically over 25° C. within a 35 m long section at year 75. The temperature variation along the drift centerline that includes the WP is even more severe, reaching over 30° C., shown in FIG. 25. These results would have been quite higher without using the enhanced axial heat conduction connection in the rock model, discussed earlier in the Example.

The temperature fields in the present Example are consistently higher than those in the previous studies^{5,6} due to the increased heat load, while less variation is seen in the drift axial direction due to the additional axial heat conduction connections described in the foregoing.

The relative humidity distributions are somewhat lower, smoother, and more symmetric than in previous results^{5,6} due to lack of a one-directional air infiltration in the present analysis. The relative humidity reaches 100% saturation only in a few places at the drift wall and WP, shown in FIGS. 24 and 25. These results support the initial assumption that evaporation in the middle and hot drift section and cold-trap condensation in the relatively cold edge drift section will take place in the central drift of Panel 2. Other drifts in the same panel will likely follow the same trend, as well as drifts in other panels.

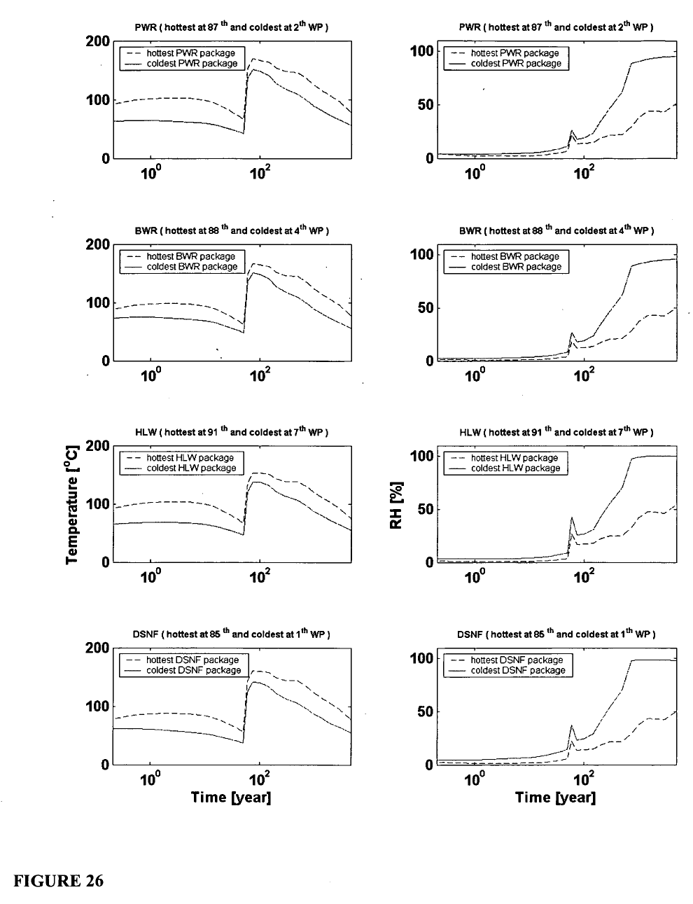

Information is gathered from the simulation results for the waste packages environment to support the evaluation of waste package material selection by Kar et al¹. FIG. 26 summarizes the WP surface temperature and relative humidity evolutions vs. time for the hottest and coldest WPs containing four different types of waste: PWR, BWR, HVW and DSNF. As shown, the WP temperatures remain below 160° C. The relative humidity is quite below 100% for the PWR and BWR packages, but reaches 100% for the coldest HLW package from about year 1000, and nearly 100% for the coldest DSNF package.

Cold-Trap Condensate Drippage

The MF simulation model not only indicates the condition for condensate formation from relative humidity reaching saturation, but also numerically quantifies the amount of liquid water condensation from the moisture transport solution.

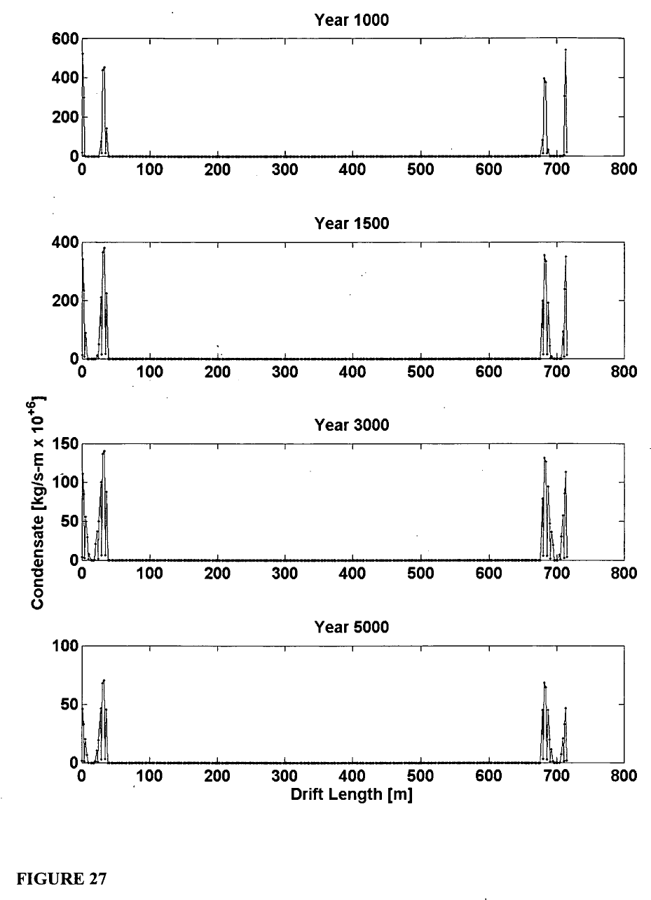

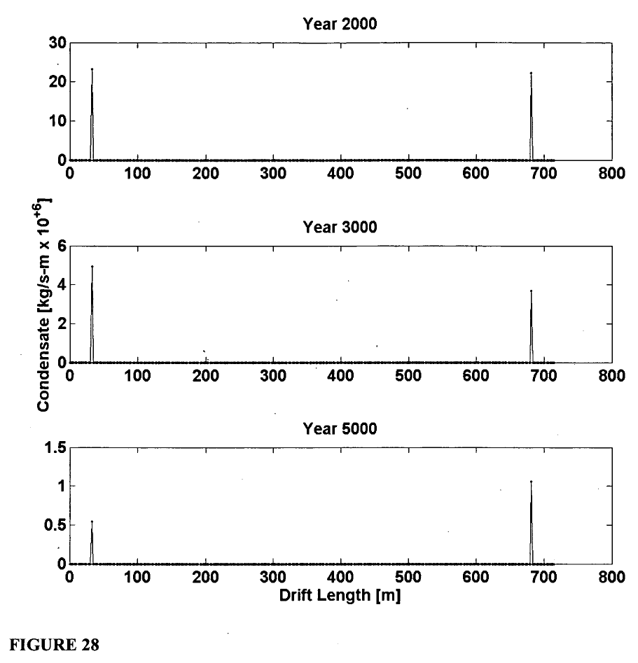

Condensation water flux results are given in FIG. 27 for the drift centerline that includes the WP, and in FIG. 28 for the drift wall. As shown in FIG. 27, condensation starts around year 1000 at the drift wall over a few cold sections with high flux rates. The condensate amount decreases with time, indicating that the total water source for condensation is thermally-driven.

In a previous work⁶, a more even distribution of condensation along the drift length was obtained. The current Example shows a fewer number of condensate locations and somewhat less condensate flux accumulation in each particular location. It appears that the sums of the total condensates in the previous and the current Example are somewhat different, particularly due to the different modeling conditions, transport mechanisms and increased heat load and partially to the fact that the present Example applies an iterated NTCF moisture model vs. an approximate, robust model in the previous study.

Condensate formation directly on cold WP is shown in FIG. 28. Although lesser in magnitude than condensation on the drift wall, direct liquid water formation on the WP is an important phenomenon since it may provide aqueous radionuclide transport to the water table at focused locations. However, none of the relatively hot WP containing PWR or BWR spent fuel is among the points that collect liquid water condensates.

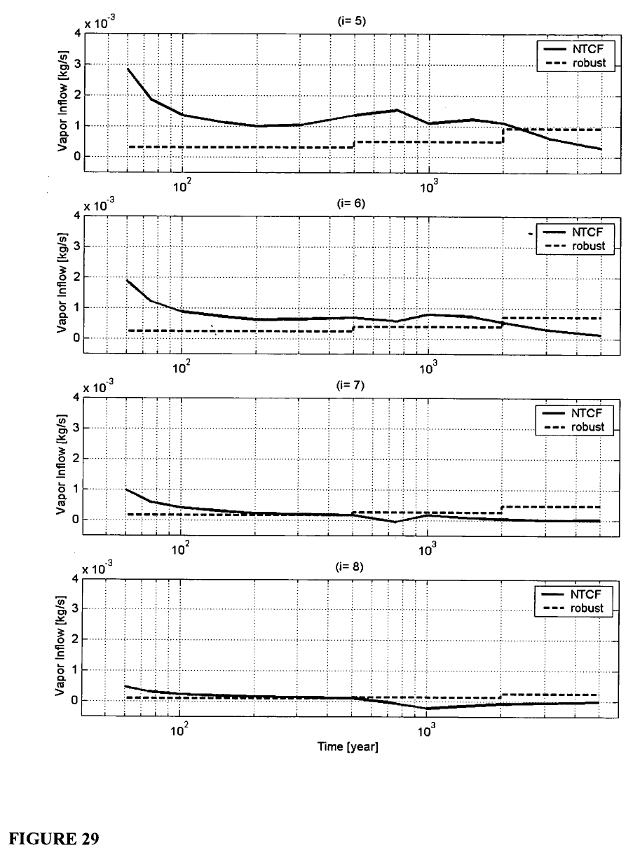

The second iteration of the NTCF moisture transport model decreased the moisture fluxes into all segments from year 1000 when compared to the values predicted from the robust model as a first iteration. The comparison of the results is shown in FIG. 29 for four drift sections. As depicted, the moisture inflow to the drift, according to the NUFT results, exceeds the initial values from the robust model along the drift. The two halves of the drift are nearly symmetrical in temperature and humidity variations at long periods of time, therefore, only half of the drift is shown for i=5 to 8.

Open-System Model Assumption Justification

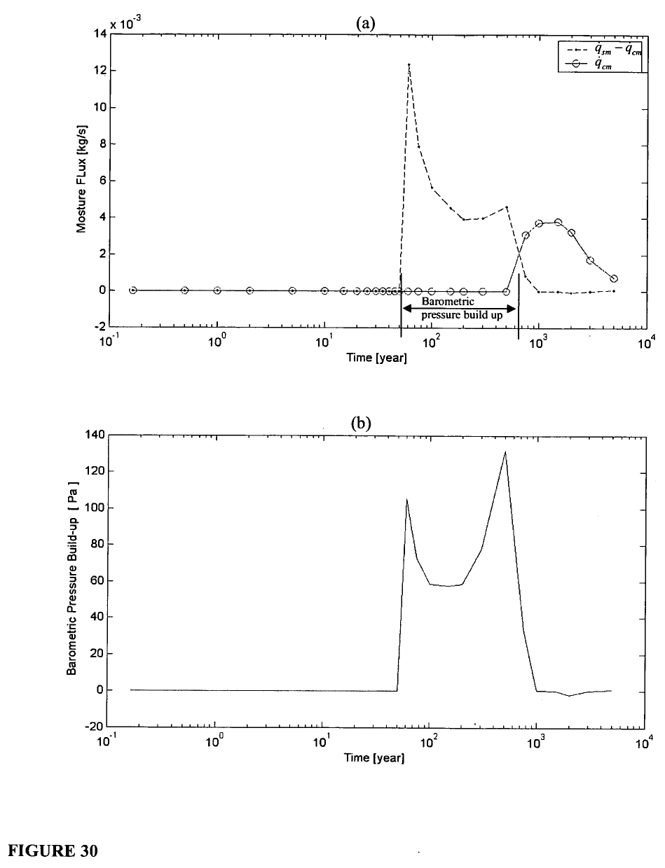

FIG. 30a shows the amount of superheated steam influx into the emplacement drift according to the CFD balancing iterations. In-drift condensation, also shown in FIG. 30a removes the steam from the system. A critical time period, between yrs 60 yrs 700, is seen regarding excess superheated steam formation that may cause pressure build-up in the emplacement drift. A separate model was used to check the discharge of this steam from the system into the unheated rockmass around the edge of the repository in horizontal direction. This separate transport mechanism is not included in the original mountain-scale transport model due to lack of axial transport connection along the drift.

Computational Performance

The NTCF modeling technique reduced the number of necessary NUFT runs, making it feasible to complete the complex calculations in a few months in spite of the average, estimated number of 150 balancing iterations with the MF model for the 5,000 year time period. For comparison, a single NUFT run with one set of boundary condition variations for 5,000 years for the complete rock domain (with entrance and exit segments) took approximately 150 hours on a small SUN workstation. The overhead of the NTCF method was that three NTCF re-functionalization was needed, requiring complete repetitions as outside iterations. Comparing run times between MF with the NTCF method and a hypothetical case without the NTCF method indicates that without using the NTCF method, but replacing it with direct NUFT runs and assuming the same number of balancing iterations, the modeling task being presented would take a minimum of 150 times 150 hours, a 2.6 years of non-stop computation.

The NTCF modeling technique not only accelerated the calculations but also provided for re-scaling the NUFT results from mountain-scale configuration to fine, drift-scale application. The NTCF model is scalable, making it a unique and efficient modeling technique.

### Conclusions

1. An integrated, pre- and post-closure thermohydrologic-airflow study was successfully completed using both mountain-scale and drift-scale rockmass model-elements using MF. The model applied a multi-scale rockmass model-element without the need for solving sub-tasks and using subsequent superposition. Heat conductivity reduction in the rockmass due to desaturation during pre-closure was automatically included in the post-closure calculations. The model integrated open-loop ventilation during pre-closure and natural air movement during post-closure within one continuous task.

2. Information is gathered from the simulation results for the waste packages environment to support the evaluation of waste package material selection by Kar et al¹. FIG. 26 summarizes the WP surface temperature and relative humidity evolutions vs. time for the hottest and coldest WPs containing four different types of waste: PWR, BWR, HVW and DSNF. As shown, the WP temperatures remain below 160° C. The relative humidity is quite below 100% for the PWR and BWR packages, but reaches 100% for the coldest HLW package from about year 1000, and nearly 100% for the coldest DSNF package.

3. In a previous work⁶, a more even distribution of condensation along the drift length was obtained. The current Example shows a fewer number of condensate locations and somewhat less condensate flux accumulation in each particular location. It appears that the sums of the total condensates in the previous and the current Example are somewhat different, particularly due to the different modeling conditions, transport mechanisms and increased heat load and partially to the fact that the present Example applies an iterated NTCF moisture model vs. an approximate, robust model in the previous study. Condensate formation directly on cold WP is shown in FIG. 28. Although lesser in magnitude than condensation on the drift wall, direct liquid water formation on the WP is an important phenomenon since it may provide aqueous radionuclide transport to the water table at focused locations. However, none of the relatively hot WP containing PWR or BWR spent fuel is among the points that collect liquid water condensates.

4. The thermohydrologic-ventilation model used an open system assumption regarding total, barometric pressure in the emplacement drift. This assumption was tested by numerical simulation and was found to be valid with only less than 100 Pa pressure increase during the critical time period for superheated steam formation, between yrs 60 and 700.

Nomenclature

qhᵢ—i^{th} rock cell heat flux vector
qmᵢ—i^{th} rock cell moisture flux vector
t—time vector
Tᵢ—i^{th} rock cell temperature vector
Pᵢ—i^{th} rock cell partial vapor pressure vector
Tinitᵢ—i^{th} rock cell initial, constant wall temperature vector
Tcᵢ .i^{th} rock cell temperature variation vector (central condition around which the NTCF model is determined).
Pcᵢ—i^{th} rock cell partial vapor pressure variation vector (central condition around which the NTCF model is determined).
hhᵢ—i^{th} rock cell temperature-driven admittance matrix of heat flux
hmᵢ—i^{th} rock cell vapor pressure-driven admittance matrix of heat flux
mhᵢ—i^{th} rock cell temperature-driven admittance matrices for the moisture flux
mmᵢ—i^{th} rock cell vapor pressure-driven admittance matrices for the moisture flux
hhᵢⱼ—ij^{th} drift segment temperature-driven admittance matrix of heat flux
hmᵢⱼ—ij^{th} drift segment pressure-driven admittance matrix of heat flux
mhᵢⱼ—ij^{th} drift segment temperature-driven admittance matrices for the moisture flux
mmᵢⱼ—ij^{th} drift segment vapor pressure-driven admittance matrices for the moisture flux
ρ—density of moist air
c—specific heat of moist air
a—molecular or eddy thermal diffusivity for laminar or turbulent flow
\dot{q}ₕ—latent heat source or sink for condensation or evaporation
T—temperature field
x, y, z—Cartesian coordinate system
ρᵥ—partial density of water vapor
D—molecular or eddy diffusivity for vapor for laminar or turbulent flow
\dot{q}_{cm}—moisture source or sink due to condensation or evaporation
\dot{q}ₛₘ—vapor flux in superheated steam form
Pᵥ—partial vapor pressure
Pₛ—saturated vapor pressure
P_{b}—barometric pressure

### REFERENCES

[1] Kar P., Danko G., Armijo J. S., Misra M., Bahrami D., 2005. “Thermal Model of an Alternative Boiling Water Reactor Spent Fuel Package Design for Yucca Mountain Repository.” Submitted to the Journal of Nuclear Technology.
[2] Danko, G., 2000. “MULTIFLUX Software Documentation.” University of Nevada, Reno, incorporated by reference herein.
[3] Nitao, J., 2000. “NUFT, Flow and Transport code V3.0s.” Software Configuration Management, Yucca Mountain Project—STN: 10088-3.0S-00, incorporated by reference herein. Prepared at the Lawrence Livermore National Laboratory.
[4] Danko, G., 2004. “Numerical Transport Code Functionalization Procedure and Software Functions.” Proceedings of ASME, Heat Transfer/Fluid Engineering, Jul. 11-15, 2004, Charlotte, N.C., USA
[5] Danko, G., Bahrami, D., 2004. “Coupled, Multi-Scale Thermohydrologic-Ventilation Modeling with MULTIFLUX” 2004 SME Annual Meeting, February 23-25, Denver, Colo.
[6] Danko, G., 2004. “Heat and Moisture Flow Simulation with MULTIFLUX.” Proceedings of ASME, Heat Transfer/Fluid Engineering, Jul. 11-15, 2004, Charlotte, N.C., USA, incorporated by reference herein.
[7] Webb, S. W. and Itamura M. T., 2004. “Calculation of Post-Closure Natural Convection Heat and Mass Transfer in Yucca Mountain Drifts.” Proceedings of ASME, Heat Transfer/Fluid Engineering, Jul. 11-15, 2004, Charlotte, N.C., USA, incorporated by reference herein.
[8] BSC (Bechtel SAIC Company). 2002. “Ventilation Model.” ANL-EBS-MD-000030 REV 01D draft. Las Vegas, Nev.: Bechtel SAIC Company, incorporated by reference herein.
[9] 2004. “TSPA for Site Recommendation”, TDR-WIS-PA-000001 REV 00 ICN 01.
[10]Danko, G., and Bahrami, D. 2002. “The Application of CFD to Ventilation Calculations at Yucca Mountain.” 28th Waste Management '02 Conference, Tucson, Ariz., pp 1-8.
[11] Kays, W. M. and Leung, E. Y., Heat Transfer in Annular Passages: Hydrodynamically Developed Turbulent Flow with Arbitrarily Prescribed Heat Flux, Int. J. Heat Mass Transfer, Vol. 6 pp. 248-249, 1963, incorporated by reference herein.
[12]Webb, S. W., Francis, N. D., Dalvit-Dunn, S., and Itamura, M. T., 2003. “Pre- and Post-Closure Natural Convection Effects in Yucca Mountain Drifts.” Proceedings, 10th Int. High-Level Radioactive Waste Management Conference, pp. 667-674.
[13]Webb, S. W., Francis, N. D., Dalvit-Dunn, S., and Itamura, M. T., 2003. “Pre- and Post-Closure Natural Convection Effects in Yucca Mountain Drifts.” Proceedings, 10th Int. High-Level Radioactive Waste Management Conference, pp. 667-674.
[14] Danko, G., Bahrami, D., and Lanka, S., 2003. “Technical Support Services for the MULTIFLUX Software.” MOL.20031208.0025, Final Report, submitted to BSC, Nevada, incorporated by reference herein.
[15] Danko, G., and Bahrami, D. 2003. “Powered, and Natural, Passive Ventilation at Yucca Mountain.” Proceedings, 10th Int. High-Level Radioactive Waste Management Conference, pp. 683-689.
[16] Farmer, J., 2003. “Chemical Environment Evolution on Alloy 22.” Presentation to the Nuclear Waste Technical Review Board, January 28, Las Vegas, Nev.

### TABLES

TABLE 1
Drift-scale NTCF subdivisions in each mountain-scale rock cell.

| | | | | | | | | |
|---|---|---|---|---|---|---|---|---|
| i | 1 | 2 | 3 | 4 | 5 | 6 | 7 | 8 |
| j | 21 | 42 | 63 | 84 | 84 | 63 | 42 | 21 |

TABLE 2
Rock model moisture flux across drift wall.

| Time period according to | | Moisture flux per linear m |
|---|---|---|
| DOE climate model⁹ | Percolation | drift |
| [year] | [mm/yr] | [kg/(m.s) × 10⁺⁶] |
| 0-600 | 12 | 2.1127 |
| 600-2000 | 20 | 3.5211 |
| 2000-5000 | 37 | 6.4789 |

TABLE 3
Input data

| | |
|---|---|
| Rock input | NUFT3.0 input deck specified in the AMR Rev01 study. |
| data: | The spatial rock domain is shown in FIGS. 3 and 4. |
| Drift | 710 m long, 5.5 m in diameter. |
| dimensions: | |
| Airflow | 15 m3/s at 25° C. intake temperature and 30% relative |
| rate: | humidity until year 50; zero axial airflow afterwards and |
| | assumed velocities for natural vertical flow rates |
| Waste | 140 waste packages in the emplacement drift. A mirrored |
| packages: | repeated sequence of eight waste packages with variable |
| | heat load, (two halves and six full) in a repeating drift |
| | segment of 35.5 m, shown in FIG. 4. |
| Waste mass | 58.48 MTU/acre. |
| load: | |
| Drip | No drip shield is assumed in the model configuration. |
| Shield: | |

In view of the many possible embodiments to which the principles of the disclosed invention may be applied, it should be recognized that the illustrated embodiments are only preferred example of the invention and should not be taken a limiting the scope of the invention. Rather, the scope of the invention is defined by the following claims. We therefore claim as our invention all that comes within the scope and spirit of these claims.

What is claimed is:

1. A nuclear material storage method comprising:
A. for a plurality of nuclear storage containers, determining an amount of heat each of the plurality of nuclear storage containers is likely to generate over a period of time;
B. determining a nuclear storage location in a material field having liquid passing through the material field;
C. determining a position for a condensation gap in the material field;
D. determining locations for first and second thermal zones in the nuclear storage location that will interact with the material field and produce the condensation gap; and
E. based on the calculated amount of heat from each of the plurality of nuclear storage containers, placing the plurality of nuclear storage containers in the material field to produce the first and second thermal zones.

2. The method of claim 1, wherein the material field is a geologic formation.

3. The method of claim 2, further comprising promoting fracture healing in the geologic formation above the first thermal zone by evaporating liquid above the first thermal zone using heat produced by the first thermal zone.

4. The method of claim 1, further comprising reducing water seepage about the first thermal zone using heat produced by the first thermal zone.

5. The method of claim 1, further comprising reducing the aqueous transport of radionuclides using heat produced by the first thermal zone.

6. The method of claim 1, further comprising promoting the stabilization of pressure in the material field by appropriately selecting thermal characteristics of the first and second thermal zones.

7. The method of claim 1, wherein the first thermal zone comprises a first nuclear storage container of the plurality of nuclear storage containers, further comprising depositing a second nuclear storage container of the plurality of nuclear storage containers in the first thermal zone.

8. The method of claim 7, wherein the first nuclear storage container is of a first type, further comprising adjusting the temperature of the first thermal zone by depositing a nuclear storage container of a second type in the first thermal zone.

9. The method of claim 1, further comprising placing the each of the plurality of nuclear storage containers on pedestals.

10. The method of claim 1, further comprising placing a drip cap on each of the plurality of nuclear storage containers.

11. The method of claim 10, wherein the drip cap is coated with a ceramic material.

12. The method of claim 10, wherein the drip cap comprises a ceramic material.

13. The method of claim 1, further comprising placing a drip cap over the plurality of nuclear storage containers.

14. The method of claim 1, wherein the plurality of nuclear storage containers are vertically positioned in the material field, further comprising supporting a roof of the material field with a top portion of each of the plurality of nuclear storage containers.

15. The method of claim 1, wherein the first and second thermal zones have a temperature below the boiling temperature of water.

16. The method of claim 1, further comprising determining a location and composition for that first and second thermal zones that will produce first and second thermal zones having desired thermal characteristics.

17. A method of altering the near-field rock environment of an emplacement comprising placing a nuclear storage container in an emplacement in a geologic formation such that a thermal field produced by the nuclear storage container creates a localized thermal zone that promotes evaporation in the geologic formation above and below the thermal field.

18. The method of claim 17, wherein the nuclear storage container is at least a first nuclear storage container and the thermal zone is a first thermal zone, further comprising placing at least a second nuclear storage container in the emplacement to create a second thermal zone such that the first and second thermal zones direct the flow of liquid in the geologic formation around the first and second thermal zones.

19. The method of claim 17, wherein the evaporation promotes fracture healing in the geologic formation.

20. A method of creating a localized thermal field in an emplacement of nuclear material in a geologic formation comprising placing a nuclear storage container in an emplacement in a geologic formation such that the nuclear storage container creates a localized thermal zone extending into the geologic formation above and below the nuclear storage container that inhibits aqueous transport in the geologic formation proximate the nuclear storage container.

21. The method of claim 20, wherein the nuclear storage container comprises a first nuclear storage container and the thermal zone is a first thermal zone, further comprising placing at least a second nuclear storage container in the emplacement, producing a second thermal zone separated from the first thermal zone byagap.

22. The method of claim 21, wherein unaltered rock formation in the geologic formation lies above and below the gap.

23. The method of claim 21, wherein the gap forms a drainage channel in the geologic formation.

24. The method of claim 21, wherein the first thermal zone has a first temperature profile and the second thermal zone has a second thermal profile, further comprising directing condensation in the geologic formation using the first and second thermal zones.

25. The method of claim 20, further comprising placing a pedestal under the nuclear storage container and placing a drip cap above the nuclear storage container.
